(19) United States
(12) Patent Application Publication
(10) Pub. No.: US 2025/0366649 A1
(43) Pub. Date: Dec. 4, 2025

(54) JUICING DEVICE

(71) Applicant: Elmira Najafi, Newport Coast, CA (US)

(72) Inventor: Elmira Najafi, Newport Coast, CA (US)

(21) Appl. No.: 19/226,692

(22) Filed: Jun. 3, 2025

Related U.S. Application Data
(60) Provisional application No. 63/655,774, filed on Jun. 4, 2024.

(51) Int. Cl. A47J 19/02

(52) U.S. Cl. CPC A47J 19/023; A47J 19/027

(57) ABSTRACT

A citrus fruit juicing device includes a hinged housing with a base member and a superior member. The base member features an arm, a hinge element, and a housing portion containing a segmented cone and circumferential juice outlets positioned adjacent to the cone. The superior member comprises an arm, a hinge element, and a housing portion that includes a battery-powered motorized claw structure configured to rotate and engage the fruit. Both the base and superior arms extend equidistantly from their respective housings, allowing the device to pivot open and closed along the hinge. The design enables secure placement and efficient extraction of juice from citrus fruits through mechanical rotation and controlled pressure.

### RELATED U.S. APPLICATION DATA

This application claims priority to Provisional Patent Application No. 63/655,774.

### FIELD OF THE INVENTION

This disclosure relates to the field of kitchen and cooking tools and accessories, particularly those used for working with citrus fruits.

### BACKGROUND

Traditional lemon squeezers, while straightforward in design, often struggle with efficiency. Their manual operation requires significant hand strength and repetitive effort. As a result, extracting juice from a large batch of citrus fruits can be time-consuming and tiring. Moreover, these squeezers may not fully extract all the juice, leaving behind valuable liquid within the pulp. The yield can be suboptimal, especially when compared to more advanced electric juicers or reamers. Yet, even the more advanced options come with drawbacks. Electric juicers are typically stationary, too large to bother moving or transporting, and unnecessarily take up precious counter space, while serving only one purpose. Setup and installation may also be inconvenient for users. Reamers may be unwieldy, not only requiring repetitive physical exertion, but also forcing uncomfortable positions for the user during use, just to extract minimal amounts of juice.

Safety is a critical aspect of kitchen tools. Traditional lemon squeezers pose several safety challenges. Firstly, their metal or plastic construction can become slippery when wet, leading to accidental slips during use. Secondly, the sharp edges of the squeezer's hinge mechanism can cause cuts or pinches if mishandled. Additionally, the force required to press the handles together can strain the user's wrists and fingers, potentially causing discomfort or injury. Ensuring safe operation while maintaining efficiency remains a delicate balance.

When using traditional lemon squeezers, managing pulp and seeds can be problematic. These squeezers often lack a built-in filter or strainer, resulting in pulp and seeds mixing with the extracted juice. While some users appreciate the added texture, others prefer a smoother juice. Separating seeds and pulp manually becomes an additional step, which can be cumbersome. Some modern juicers address this issue by incorporating filters or adjustable pulp settings, allowing users to customize their juice consistency.

Traditional citrus juicing devices may offer simplicity, but come with trade-offs in terms of efficiency, safety, versatility, portability, durability, and pulp management. As kitchen technology evolves, users must weigh these factors when choosing the right tool for their citrus juicing needs.

### SUMMARY

The present disclosure relates to a citrus fruit juicing device having an improved structural and functional configuration for efficient juice extraction. In particular, the juicing device comprises a hinged housing with a base member and a superior member that are pivotally connected to facilitate an open and closed operating position. The base member includes an arm, a housing portion, and a segmented cone positioned within an interior concavity, with juice outlets arranged circumferentially around the cone for effective juice collection and drainage.

The superior member comprises a complementary arm, a housing portion, and a pressable enclosure. Within the superior housing portion resides a motorized claw structure configured to rotate upon user actuation. The enclosure houses the motor, battery, and control circuitry (e.g., a PCB), and is structured to actuate the claw mechanism when pressed. The claw structure includes a central spinner and radially extending claws that engage the citrus fruit from above. Together, the segmented cone and rotating claw structure work in tandem to enhance juicing performance with minimal user effort.

The invention enables compact, battery-powered operation, and may be constructed to allow easy disassembly for cleaning or maintenance. Variations of the device can include differing claw configurations, cone segment arrangements, and activation mechanisms, all within the scope of the disclosed system.

### BRIEF DESCRIPTION OF THE DRAWINGS

FIG. 1 illustrates a top right perspective view of a juicing device in accordance with an embodiment of the present disclosure.

FIG. 2 illustrates a bottom left perspective view of a juicing device in accordance with an embodiment of the present disclosure.

FIG. 3 illustrates a top right perspective view of the juicing device in a half-open configuration in accordance with an embodiment of the present disclosure.

FIG. 4 illustrates a top left perspective view of the juicing device in a fully open configuration and having motor components in accordance with an embodiment of the present disclosure.

FIG. 5 illustrates a top view of the juicing device in a fully open configuration in accordance with an embodiment of the present disclosure.

FIG. 6 illustrates an exploded perspective view of the juicing device in a fully open configuration in accordance with an embodiment of the present disclosure.

FIG. 7a illustrates an exploded perspective view of a claw structure in accordance with an embodiment of the present disclosure.

FIG. 7b illustrates a side view of a claw structure separated from a shell in accordance with an embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The present disclosure includes an electronically operable juicing device that is well-suited for extracting juice from lemons, limes, oranges, and other citrus fruits. In an exemplary embodiment, the juicing device is battery-powered, making it highly portable. In one example, battery recharging is accomplished using a USB Type-C, or USB-C, port. The juicing device further has a durable, streamlined construction, making it easy to clean. Safety features are included in the device, further promoting ease of use. The device offers efficient, convenient juicing, and versatile application for numerous food preparation scenarios. The device is designed to be both ergonomic and with an elegant, attractive aesthetic, to enhance a user's experience.

The present invention improves upon traditional lemon squeezing devices by implementing a motorized and rotatable claw component, the motor being in electrical communication with electronic components, the electronics receiving an activation signal from the user via a pressed button. The electronic components include a soldered printed circuit board (PCB) and circuitry. The employed techniques of PCB fabrication promote the production of compact and reliable circuit boards. Programmable aspects of the electronics may include firmware that is developed to control and manage the electrical features of the juicing device. Electrical schematic diagrams are designed using proprietary software, ensuring that the device meets certification standards and regulatory requirements. U.S. certification standards include those for the FCC (for electromagnetic compatibility and radio frequency interference compliance) and RoHS (for compliance with environmental protection).

A digital 3D model of the juicing device can be used for the process of 3D printing one or more components of the device, especially those found on or forming the exterior of the device. A goal of the 3D modeling process is to ensure both functionality and aesthetics. In initial development stages, detailed 3D drawings can facilitate the fabrication of a functional prototype with precise dimensions and specifications. A 3D printing production method would emphasize product strength and durability, and further make the device waterproof. The product development stage utilizes comprehensive prototype testing to verify functionality, performance, reliability, and compliance with product standards and regulations. Testing may include circuit testing, PCB testing, firmware testing, 3D model testing, 3D print testing, and final overall testing. Final testing may include a detailed checklist of desired outputs and performance metrics for thorough validation.

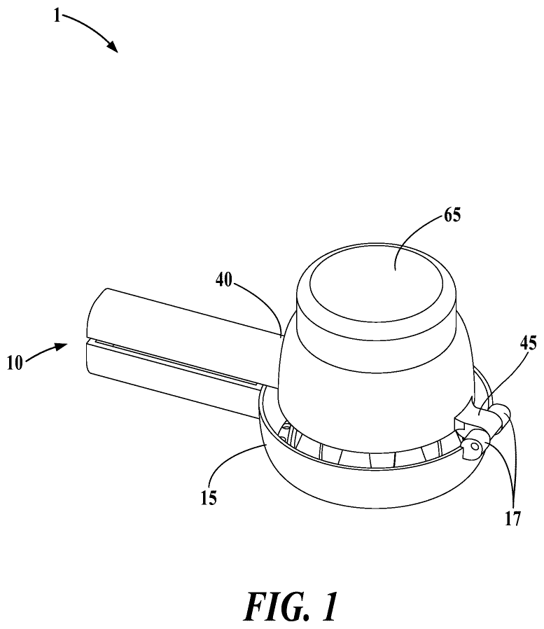

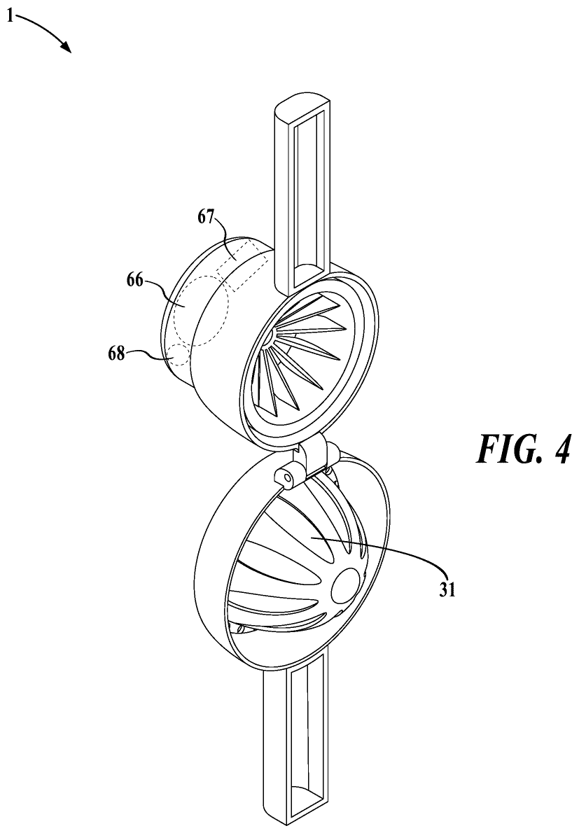

Referring to FIG. 1, in a preferred embodiment, the present invention provides a citrus fruit juicing device 1 comprising a hinged housing 10 with base member 15 and superior member 40. An exemplary hinged housing 10 includes a base hinge element 17 and a superior hinge element 45. The base hinge element 17 protrudes from the base member 15 while the superior hinge element 45 protrudes from the superior member 40. The housing members are pivotally connected via the hinge elements, such that the superior member 40 is generally moved vertically and away from the base member 15 in order to form an open configuration for the juicing device 1. FIG. 1 depicts a closed configuration for the device 1. The device 1 further includes a superior enclosure, or button 65, for housing electronics and motor components. In an exemplary embodiment, the superior enclosure 65 doubles as a button for activating a motor (see motor 66 in FIG. 4) via the connected electronics, and is pressable by a user of the juicing device 1.

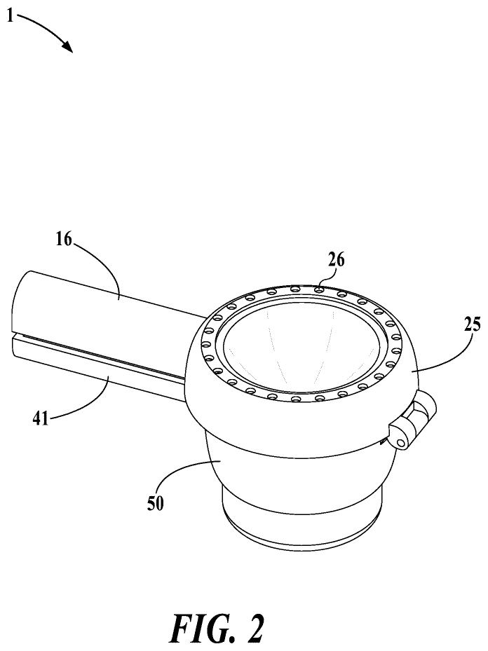

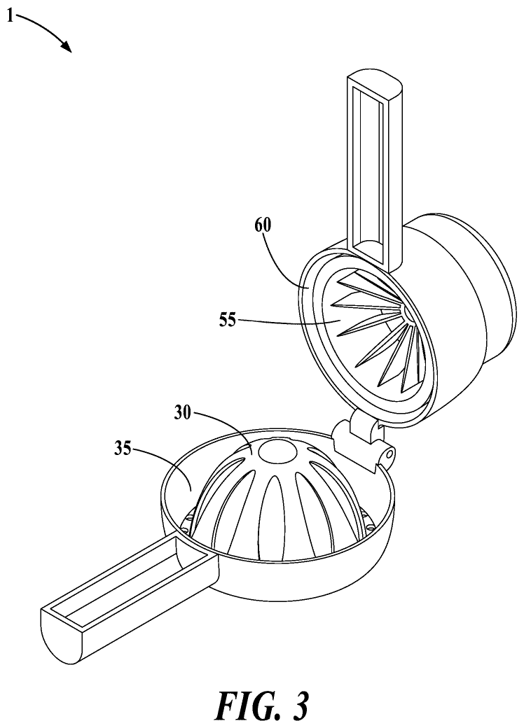

Referring to FIG. 2, the base member 15 further comprises a base arm 16 and base housing portion 25, while the superior member 40 further comprises a superior arm 41 and superior housing portion 50. Both housing portions are circular concavities suitable for housing interior juicing components. Each concave portion forms an interior space opposing exterior surfaces. The base arm 16 is proximally attached to the base housing portion 25, having a distal end that extends a length away from the base housing portion 25. Likewise, the superior arm 41 is proximally attached to the superior housing portion 50, having a distal end that extends a length away from the superior housing portion 50. In an exemplary embodiment, the arms extend equidistantly away from their respective housings. As depicted in FIG. 2, on the exterior of the base housing portion 25, a circular bottom face is circumferentially lined with a series of juice outlets 26. The juice outlets 26 are holes running through the base housing portion 25, opening into an interior concavity 35 (see base interior concavity 35 of FIG. 3). The superior enclosure 65 is positioned above the superior housing portion 50, being pressably attached to it, and contains components that are in structural and electrical communication with those found within the superior housing portion 50.

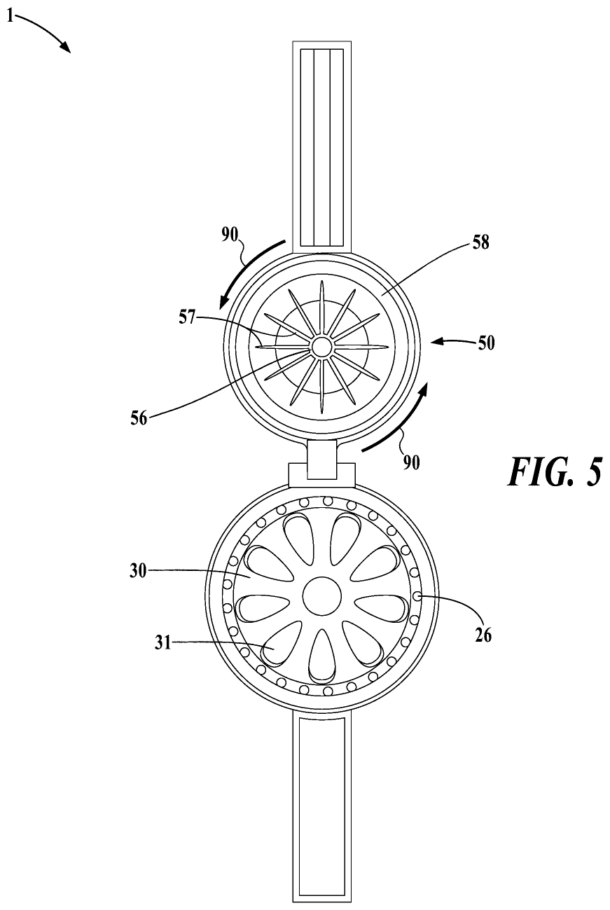

Referring to FIG. 3, a half-open, or 90 degree configuration of the juicing device 1 is depicted. The superior member 40 of the hinged housing 10 is rotated generally upward and pivotally via the hinge elements, such that interior components found within the housing portions are exposed. These components include a segmented cone 30 protruding from the base interior concavity 35, the cone 30 having a distal end that extends away from a circumferential top edge of the base housing portion 25. The cone 30 is well-suited for receiving the juice-containing interior portion of a cut citrus fruit, and includes a regularly spaced series of circumferentially positioned indentations, or segments 31 (see cone segments 31 of FIG. 4), these features promoting more efficient juicing. Another interior component includes the motorized claw structure 55 housed within a superior interior concavity 60 of the superior housing portion 50. One or more elements of the claw structure are rotatably engaged with the superior interior concavity 60, such that the claws (see claws 57 of FIG. 5) are spinnable. In one example of usage, while the juicing device 1 is in an open configuration as depicted, a user fixes a lemon onto the segmented cone 30, then closes and squeezes the housing arms to achieve the closed configuration of FIG. 1. An optimal level of squeezing pressure promotes efficient juicing while not interfering with operation of the motor 66. The user then activates a start button, or depresses the pressable superior enclosure 65. The electrically associated motor 66 engages in response to button activation, causing the claws to rotate. As the claws rotate, they apply pressure to the lemon, squeezing it against the segmented cone 30. This rotational motion effectively crushes the lemon, causing its juice to flow out from the bottom of the device 1, via the juice outlets 26. The user can then collect the extracted juice from the bottom outlets 26 for further use. Thus, the juicing device 1 ensures efficient and effortless extraction of citrus juices, providing users with a convenient solution for their juicing needs.

Referring to FIG. 4, a fully open, or 180 degree configuration of the juicing device 1 is depicted. In some embodiments, the juicing device 1 may be capable of opening at yet greater angles for other open configurations, these positions not depicted for reasons of practical usage, since the device typically would not need to be opened any wider for its main purpose. The superior enclosure 65 houses the motor 66, a PCB 67, and a battery 68 for powering the motor 66 and device 1. The PCB 67 can be programmed with firmware that is developed to control and manage the electrical and operational features of the juicing device.

Referring to FIG. 5, a top view of the 180 degree open configuration is depicted. The claw structure 55 further comprises a shell 58 and claws 57 extending radially away from an origin, or central spinner 56. In one embodiment, the claws 57 rotate independently of the shell 58, which is fixed to the superior housing portion 50. In another example, the claws 57 are fixed to the shell 58 via the central spinner 56, and thus both the shell 58 and claws 57 rotate, as a single structure, relative to the superior housing portion 50. Motion arrows 90 indicate the rotation of the claws 57 within the superior housing portion 50. The top view of this fully open configuration shows the interior openings of the juice outlets 26, which are circumferentially and adjacently disposed around the segmented cone 30. The juice outlets 26 are optimally sized for efficient juice flow, while preventing the undesirable passage of seeds or pulp through the outlets 26. Other embodiments may envision differently shaped holes or filters capable of allowing some passage of pulp with the juice, while still blocking seed passage. These or other embodiments may include alternating patterns of varied outlet sizes.

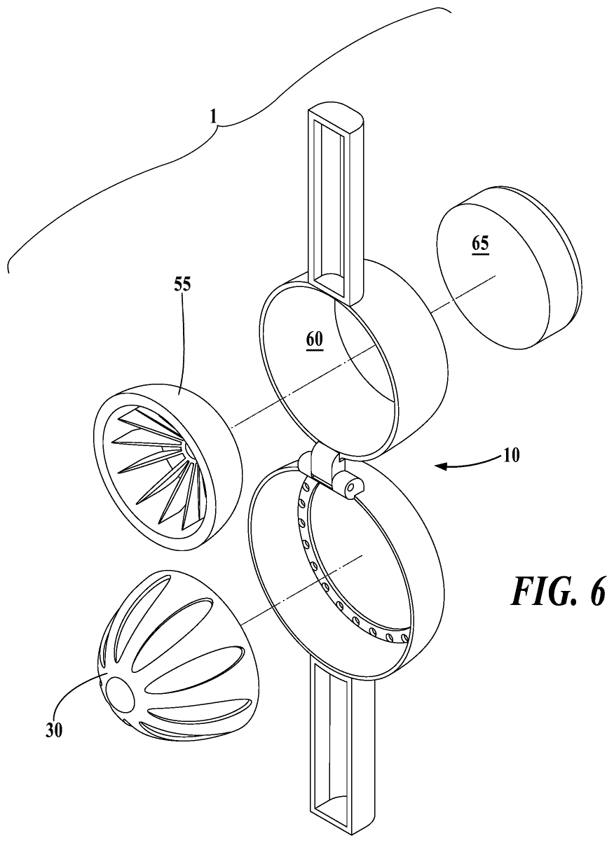

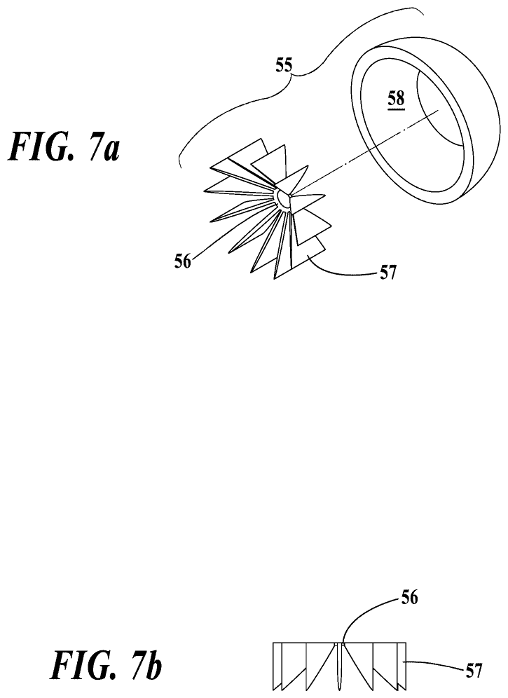

Referring to FIG. 6, an exploded perspective view of the juicing device 1 in the 180 degree open configuration is depicted. The hinged housing 10 holds the motorized claw structure 55 within its superior interior cavity 60 as it rotates. FIG. 7a depicts an exploded motorized claw structure 55, with the central spinner 56 and claws 57 separated from the shell 58. An exemplary embodiment includes a single piece having the central spinner 56 and claws 57. In another example, the central spinner 56 is a separate component from the claws 57. FIG. 7b depicts a side view of the claws 57 and central spinner 56 alone.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A citrus fruit juicing device comprising:
(a.) a hinged housing, the hinged housing comprising:
(i.) a base member having an arm, a hinge element, and a housing portion, the base housing portion comprising a segmented cone and juice outlets, the juice outlets running through the base housing portion and positioned circumferentially and adjacently around the segmented cone, the base arm being proximally attached to and having a distal end that extends a length away from the base housing portion; and,
(ii.) a superior member having an arm, a hinge element, and a housing portion, the superior housing portion comprising a motorized claw structure configured to rotate via battery operation, the superior arm being proximally attached to and having a distal end that extends a length away from the superior housing portion, the base arm and superior arm extending equidistantly away from their respective housings.

2. The device of claim 1, wherein the housing members are pivotally connected via the hinge elements, the superior member being rotated away from the base member in order to form an open configuration for the juicing device.

3. The device of claim 2, wherein the segmented cone comprises a regularly spaced series of circumferentially positioned segments.

4. The device of claim 3, wherein the base housing portion further comprises an interior concavity within which the segmented cone is housed, the base interior concavity forming an interior space opposing exterior surfaces.

5. The device of claim 4, wherein the superior housing portion further comprises an interior concavity within which the motorized claw structure is positioned, the superior interior concavity forming an interior space opposing exterior surfaces.

6. The device of claim 5, wherein the superior member further comprises an enclosure that is pressably attached to the superior housing portion.

7. The device of claim 6, wherein the superior enclosure houses a motor, PCB, and battery, and is configured to rotate the motorized claw structure when pressed.

8. The device of claim 7, wherein the motorized claw structure comprises a central spinner, claws, and a shell, the central spinner being an origin from which the claws extend away radially.

9. The device of claim 8, wherein one or more of the central spinner, claws, and shell are rotatably engaged with the interior concavity of the superior housing portion.

10. A juicing device comprising:
(a.) a hinged housing, the hinged housing comprising:
(i.) a base member having an arm, a hinge element, and a housing portion, the base housing portion comprising a segmented cone and juice outlets, the segmented cone comprising a regularly spaced series of circumferentially positioned segments, the base housing portion further comprising an interior concavity within which the segmented cone is housed; and,
(ii.) a superior member having an arm, a hinge element, and a housing portion, the superior housing portion comprising a motorized claw structure configured to rotate via battery operation, the superior housing portion further comprising an interior concavity within which the motorized claw structure is positioned, the superior member further comprising an enclosure that is pressably attached to the superior housing portion, the enclosure housing a motor, a PCB, and a battery, the enclosure configured to rotate the motorized claw structure when pressed.
